(19) United States
(12) Patent Application Publication
(10) Pub. No.: US 2014/0183423 A1
(43) Pub. Date: Jul. 3, 2014

(54) FINE PARTICLES HAVING A MULTIPLE STRUCTURE, POLYMER FILM FOR SMART GLASS AND METHOD OF MANUFACTURING THE SAME

(71) Applicant: Hyundai Motor Company, (US)

(72) Inventors: Sang-Young Kim, Hwasung (KR); Se-Jung Kim, Suwon (KR); Gi-Ra Yi, Suwon (KR); Seung-Hyun Kim, Suwon (KR)

(73) Assignee: HYUNDAI MOTOR COMPANY, Seoul (KR)

(21) Appl. No.: 13/873,538

(22) Filed: Apr. 30, 2013

(30) Foreign Application Priority Data
Dec. 27, 2012 (KR) 10-2012-0154789

(51) Int. Cl. G02B 1/00

(52) U.S. Cl. CPC G02B 1/00
USPC 252/583

(57) ABSTRACT

Disclosed are fine particles having a multiple structure, a polymer film for smart glass, and a method of manufacturing the same. More particularly, disclosed are fine particles having a multiple structure, which include a reaction portion containing iron oxide nanoparticles, carbon black and/or carbon nanotubes, and at least one non-reaction portion containing silica and/or titania nanoparticles, and which rotate by means of an electric field or a magnetic field, a polymer film for smart glass including the fine particles to control light transmissivity, and a method of manufacturing the same.

### CROSS-REFERENCE TO RELATED APPLICATION

This application claims priority under 35 U.S.C. §119 to Korean Patent Application No. 10-2012-0154789, filed on Dec. 27, 2012, in the Korean Intellectual Property Office, the disclosure of which is incorporated herein by reference in its entirety.

### BACKGROUND

(a) Technical Field

The present disclosure relates to fine particles having a multiple structure, a polymer film for smart glass, and a method of manufacturing the same. More particularly, the present invention relates to fine particles having a multiple structure, which rotates by means of an electric field or s magnetic field, a polymer film for smart glass including the fine particles to control light transmissivity, and a method of manufacturing the same.

(b) Background Art

In general, glass is installed at the rear, front and left and right sides of an automobile to allow viewing therethrough to the interior and exterior of the automobile.

In recent years, interest in the smart glass-related technology capable of controlling light transmissivity has increased. In general, the conventional smart glass-related technology includes liquid crystal display technology, electrochromic technology, photochromic technology, thermochromic technology, and technology using dipole particles.

The liquid crystal display technology changes the orientation of anisotropic liquid crystal molecules included in a liquid crystal panel by applying voltage to the liquid crystal molecules, and alters the light transmissivity. Generally, however, the liquid crystal display technology has a problem in that the liquid crystal panel has a large thickness and low durability and may not be easily curved.

The electrochromic technology changes the color of a material using an electrochemical reaction. The electrochromic technology has advantages in that it shows high visibility similar to that of paper printing, and also has a very low drive voltage. However, a response time for coloration and decoloration is very slow and a residual image remains during decoloration.

The thermochromic technology changes reversible optical properties, such as color, color intensity and ultraviolet ray (UV) transmittance, in which any level of temperature is represented by the starting point. However, the thermochromic technology has a problem in that the reversible optical properties may be adjusted by heat.

The smart glass-related technology using dipole particles has the best light-shielding properties and response time and shows excellent properties such as durability, manufacturing cost and large scaling in terms of productivity. However, this technology requires application of a high drive voltage of at least 30 V, and a continuous power supply is also required.

The present invention provides fine particles having a multiple structure, which include a reaction portion which reacts by means of a magnetic field or an electric field and a polymer film in which infrared rays are protected and bistability is realized by the fine particles to reduce a drive energy, and a method of manufacturing the same.

According to one aspect, the present invention provides fine particles having a multiple structure characterized in that they include a reaction portion containing iron oxide nanoparticles, carbon black or carbon nanotubes, and at least one non- reaction portion containing silica or titania nanoparticles.

According to various embodiments, the reaction portion further includes titania nanoparticles.

According to a further aspect, the present invention provides a polymer film for smart glass that includes the fine particles having a multiple structure, and an elastomer.

According to various embodiments, the elastomer is polydimethylsiloxane (PDMS).

According to a further aspect, the present invention provides a method of manufacturing a polymer film for smart glass comprising: first operation of preparing nanoparticles (S10), a second operation of preparing a nanoparticle dispersion solution by dispersing the nanoparticles in a photocurable resin and adding a photoinitiator to the resulting dispersion solution (S20), a third operation of manufacturing fine particles having a multiple structure by inputting the nanoparticle dispersion solution into at least two glass microdevices, which are disposed in an outer tuber through which water including a surfactant flows and coupled to each other in a longitudinal direction, to form droplets and curing the nanoparticle dispersion solution (S30), and a fourth operation of manufacturing a polymer film by mixing the fine particles having a multiple structure with an elastomer (S40). The method may further include a fifth operation of providing the fine particles having a multiple structure with fluidity by inputting the polymer film into a silicone oil.

According to various embodiments, the nanoparticles include iron oxide/titania nanoparticles for forming a reaction portion and silica or titania nanoparticles for forming a non-reaction portion.

According to various embodiments of the present invention, the iron oxide nanoparticles are a reaction product between an iron oxide precursor and a solvent. The iron oxide precursor and solvent may be any conventional iron oxide precursors and solvents According to an exemplary embodiment, the iron oxide precursor is iron(III) acetylacetonate, and the solvent is a mixture of octanol or 1,2-hexadecanediol and benzyl ether.

According to various embodiments of the present invention, the silica nanoparticles are a reaction product between a silica precursor, a solvent and a catalyst. The silica precursor, solvent and catalyst may be any conventional silica precursor, solvent and catalyst. According to an exemplary embodiment, the silica precursor is silicon alkoxide, the solvent is ethanol, and the catalyst is ammonium hydroxide.

According various embodiments of the present invention, the titania nanoparticles are a reaction product between a titania precursor, a solvent and a catalyst. The titania precursor, solvent and catalyst may be any conventional titania precursor, solvent and catalyst. According to an exemplary embodiment, the titania precursor is titanium alkoxide, the solvent is a mixture of methanol or ethanol and acetonitrile, and the catalyst is a mixture of organoamine and water.

According to one exemplary embodiment of the present invention, the photocurable resin is trimethylolpropane ethoxylate triacrylate.

According to one exemplary embodiment of the present invention, the photoinitiator is 2-hydroxy-2-methyl-1-phenyl-propan-1-one (Darocure 1173).

According to one exemplary embodiment of the present invention, the second operation (S20) is performed by adding the photoinitiator at a content of about 0.1 to 5% by volume, based on the total volume of the nanoparticle dispersion solution.

According to one exemplary embodiment of the present invention, each of the glass microdevices are a glass capillary tube having a diameter of about 50 to 100 μm.

According to one exemplary embodiment of the present invention, the surfactant is sodium dodecyl sulfate (SDS) or a block terpolymer.

According to one exemplary embodiment of the present invention, the third operation (S30) is performed by curing the nanoparticle dispersion solution by irradiating the nanoparticle dispersion solution with ultraviolet rays having a wavelength of about 200 to 400 nm at a UV intensity of about 0.1 to 2.0 J/cm².

According to one exemplary embodiment of the present invention, the elastomer is PDMS.

Other features and aspects of the present invention will be apparent from the following detailed description, drawings and claims.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic diagram illustrating a degree of light transmissivity according to a direction of rotation of fine particles having a multiple structure according to one exemplary embodiment of the present invention;

FIG. 2 is a flowchart illustrating a method of manufacturing a polymer film for smart glass according to one exemplary embodiment of the present invention;

FIG. 3 is a conceptual diagram for manufacturing the fine particles having a multiple structure according to one exemplary embodiment of the present invention;

FIG. 4 is an enlarged image of iron oxide nanoparticles prepared according to one exemplary embodiment of the present invention;

FIG. 5 is an enlarged image of silica nanoparticles prepared according to one exemplary embodiment of the present invention;

FIG. 6 is an enlarged image of titania nanoparticles prepared according to one exemplary embodiment of the present invention;

FIG. 7 is an enlarged image of fine particles having a double structure according to one exemplary embodiment of the present invention; and.

FIG. 8 is an enlarged image of fine particles having a triple structure according to one exemplary embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below.

Prior to the description, it should be understood that the terminology used in the specification and appended claims should not be construed as limited to general and dictionary meanings, but interpreted based on the meanings and concepts corresponding to technical aspects of the present invention on the basis of the principle that the present inventors are allowed to define the terms appropriately for the best explanation. Therefore, the description proposed herein is just a preferable example for the purpose of illustrations only, not intended to limit the scope of the invention, so it should be understood that other equivalents and modifications could be made thereto without departing from the scope of the invention.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

One aspect of present invention provides fine particles having a multiple structure including a reaction portion and at least one non-reaction portion. More particularly, the reaction portion preferably includes iron oxide nanoparticles, carbon black and/or carbon nanotubes, and the non-reaction portion preferably includes silica and/or titania nanoparticles. More preferably, the reaction portion further includes titania nanoparticles having reflexibility.

That is, the reaction portion serves to cause the particles to react in the electric field or magnetic field to rotate the fine particles, and the non-reaction portion serves to protect the particles from infrared rays. Here, the fine particles may have a double structure, with the fine particles having one reaction portion and one non- reaction portion, or may have a multiple structure such as a triple structure, with the fine particles having one reaction portion and two non-reaction portions. Any multiple number of structures with any combination of numbers of reaction portions and non-reaction portions can be provided.

Another aspect of present invention provides a polymer film for smart glass including the above-described fine particles having a multiple structure, and an elastomer.

FIG. 1 is a schematic diagram illustrating a degree of light transmissivity according to a direction of rotation of fine particles having a multiple structure according to one exemplary embodiment of the present invention. As shown in FIG. 1, the fine particles having a double structure or the fine particles having a triple structure includes a reaction portion 10 and a non-reaction portion 20. These portions 10, 20 serve to control light transmissivity as the fine particles rotate by means of the electric field or magnetic field when the fine particles are applied to smart glass together with the elastomer.

The elastomer can be any conventional elastomer, and according to an exemplary embodiment, the elastomer is polydimethylsiloxane (PDMS).

In FIG. 1, the arrow is sized to indicate a size (intensity) of light. In this case, light transmissivity may be controlled by orientation of the fine particles as light transmits through the non-reaction portion 20, and bistability may be realized to save drive energy.

Still another aspect of present invention provides a method of manufacturing a polymer film for smart glass.

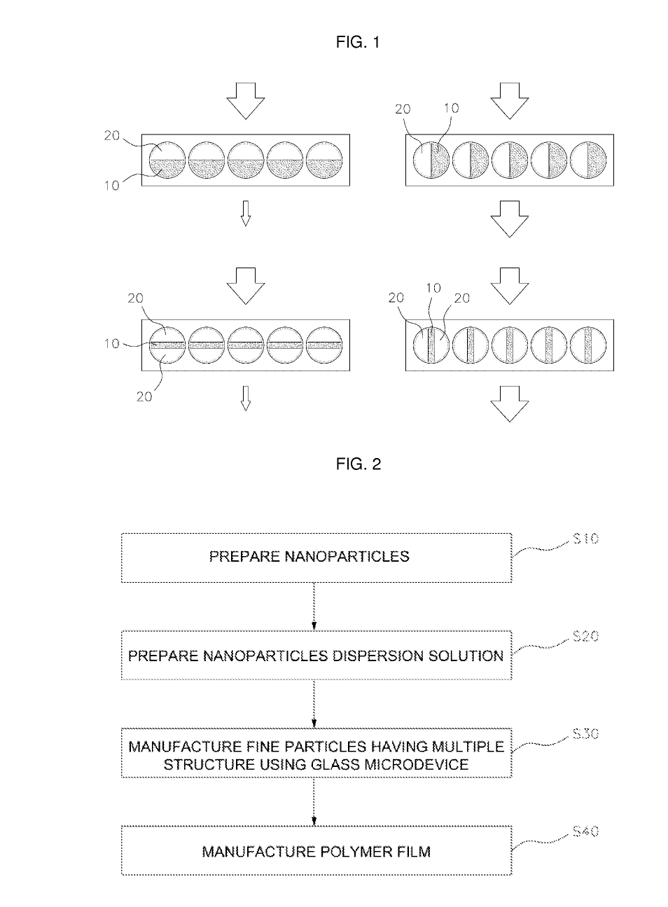

FIG. 2 is a flowchart illustrating a method of manufacturing a polymer film for smart glass according to one exemplary embodiment of the present invention. As shown in FIG. 2, the method includes a first operation of preparing nanoparticles (S10), a second operation preparing a nanoparticle dispersion solution (S20), a third operation of manufacturing fine particles having a multiple structure (S30), and a fourth operation of manufacturing a polymer film (S40).

These operations will now be described in further detail in connection with an exemplary embodiment:

1. First Operation of Preparing Nanoparticles (S10)

The nanoparticles preferably include iron oxide/titania nanoparticles for forming a reaction portion, and silica or titania nanoparticles for forming a non-reaction portion.

1) Preparation of Iron Oxide Nanoparticles

The iron oxide nanoparticles may be prepared as a reaction product between an iron oxide precursor and a solvent using a thermal cracking method. More particularly, the iron oxide nanoparticles may be formed by mixing an iron oxide precursor and a solvent and reacting the resulting mixture at a temperature of about 210 to 280° C. at which the iron oxide precursor can be thermally cracked.

In this case, iron(III) acetylacetonate may be used as the iron oxide precursor, and the solvent may be a mixture of octanol or 1,2-hexadecanediol and benzyl ether.

2) Preparation of Silica Nanoparticles

The silica nanoparticles may be prepared as a reaction product between a silica precursor, a solvent and a catalyst using a sol-gel process.

In this case, a silicon alkoxide, such as tetraethyl orthosilicate, may be used as the silica precursor, the solvent may be ethanol, and the catalyst may be ammonium hydroxide. Here, a size of the silica nanoparticles may be adjusted according to concentrations of the silica precursor and ammonia.

3) Preparation of Titania Nanoparticles

The titania nanoparticles may be prepared as a reaction product between a titania precursor, a solvent and a catalyst using a sol-gel process.

In this case, a titanium alkoxide, such as titanium tetraisopropanol, may be used as the titania precursor, a mixture of acetonitrile and an alcohol, such as methanol or ethanol, may be used as the solvent, and the catalyst may be a mixture of organoamine and water. The titania nanoparticles with a uniform size are prepared by adding a catalyst, for example, a mixture of organoamine and water, to the prepared solvent to form a mixture, followed by adding a titania precursor to the mixture.

2. Second Operation Preparing a Nanoparticle Dispersion Solution (S20)

A solution in which the nanoparticles are dispersed is prepared, A photocurable resin, such as trimethylolpropane ethoxylate triacrylate, which is easily miscible with ethanol is preferably used.

More particularly, each of the nanoparticless prepared in the first operation are dispersed in ethanol, and a photocurable resin is mixed with the resulting dispersion solution. Thereafter, a photocurable nanoparticle dispersion solution containing uniformly dispersed nanoparticles may be prepared by evaporating the ethanol, for example, by using a rotary evaporator or the like.

In this case, a photoinitiator that serves to initiate a polymerization reaction of the solution may be 2-hydroxy-2-methyl-1-phenyl-propan-1-one (Darocure 1173). To prepare the nanoparticle dispersion solution, the photoinitiator may be added at a content of about 0.1 to 5% by volume, based on the total volume of the nanoparticle dispersion solution.

3. Third Operation of Manufacturing Fine Particles having a Multiple Structure (S30)

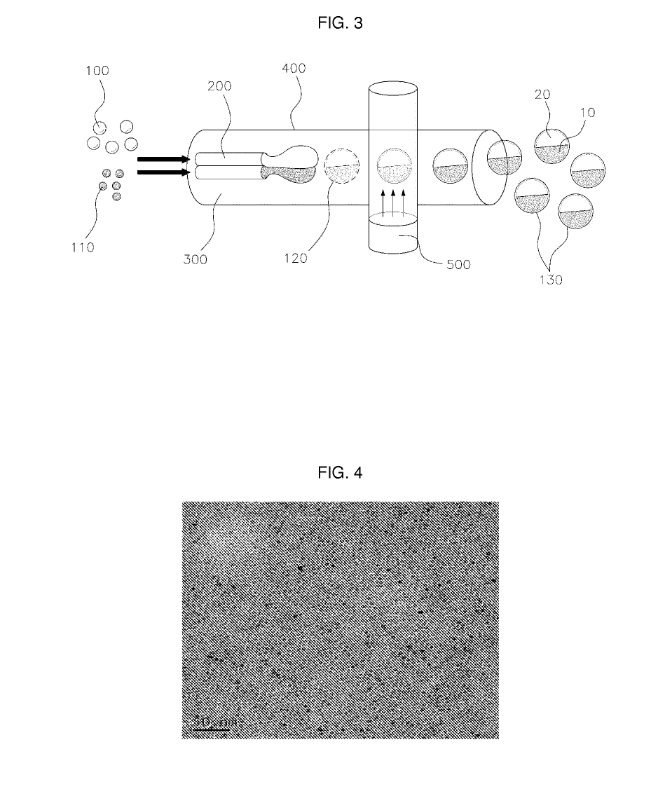

FIG. 3 is a conceptual diagram for manufacturing the fine particles having a multiple structure according to one exemplary embodiment of the present invention. As shown in FIG. 3, the fine particles 130 having a multiple structure may be manufactured by inputting the nanoparticle dispersion solution prepared in the second operation (S20) into at least two glass microdevices(e.g. 200_, which are disposed in an outer tuber 400. Water 300 including a surfactant flows through the microdevices, which are coupled to each other in a longitudinal direction, to form droplets 120. Thereafter, the nanoparticle dispersion solution is cured.

In this case, each of the glass microdevices may be a glass capillary tube having a diameter of about 50 to 100 μm. Here, a commercially available micropipette puller may be used, or the glass microdevice may be manually prepared by applying heat to the glass microdevice.

The number of the glass microdevices may be set according to a desired configuration of the fine particles. That is, two glass microdevices may be used to manufacture fine particles having a double structure, and three glass microdevices may be used to manufacture fine particles having a triple structure, etc.

According to one exemplary embodiment, a nanoparticle dispersion solution including the iron oxide/titania nanoparticles 110 for forming a reaction portion 10, and silica or titania nanoparticles 100 for forming a non-reaction portion 20 are fed into two glass capillary tubes 200 coupled to each other in a longitudinal direction, respectively, to form droplets 120. Then, the droplets 120 are cured with UV rays radiated from a UV lamp 500 to form fine particles 130 having a multiple structure. In this case, the droplets 120 may be cured by irradiating the droplets 120 with UV rays having a wavelength of about 200 to 400 nm at a UV intensity of about 0.1 to 2.0 J/cm².

According to preferred embodiments, a block terpolymer such as sodium dodecyl sulfate (SDS) or poly(ethylene glycol)-b-poly(propylene glycol)-b-poly(ethylene glycol) may be used as the surfactant.

4. Fourth Operation of Manufacturing a Polymer Film (S40)

A polymer film may then be manufactured by mixing the fine particles 130 having a multiple structure manufactured in the third operation with an elastomer, such as PDMS.

More particularly, the polymer film is manufactured by drying the fine particles 130 having a multiple structure, and curing the fine particles (e.g. curing at approximately 70° C. for approximately 15 minutes).

The polymer film may be further input into a silicone oil to provide the fine particles having a multiple structure with fluidity (fifth operation).

The light transmittance may be controlled by applying the magnetic field or electric field to the fine particles having a multiple structure provided with the fluidity so as to rotate the fine particles.

### Example 1

Hereinafter, preferred embodiments of the present invention will be described in detail referring to the accompanying drawings. However, the description proposed herein is merely a preferable example for the purpose of illustrations only, not intended to limit the scope of the invention, so it should be understood that changes and modifications could be made thereto without departing from the spirit and scope of the invention.

4 g of iron(III) acetylacetonate and 20 ml of octanol were stirred for an hour, and then heated at approximately 210° C. When the reaction was completed, the resulting high-temperature mixture solution was cooled to room temperature, and 30 ml of ethanol was added to the mixture solution to induce precipitation from the mixture solution. 10 ml of toluene was added to the obtained precipitate, thereby dissolving the precipitate. Subsequently, 30 ml of ethanol was added to the resulting mixture, and the mixture was then centrifuged to obtain iron oxide nanoparticles.

FIG. 4 is an enlarged image of the iron oxide nanoparticles prepared according to one exemplary embodiment of the present invention, confirming the presence of the nanoparticles having a spherical structure with a size of approximately 7 nm.

Approximately 100 ml of ethanol and approximately 7.5 ml of ammonium hydroxide were stirred at room temperature for 30 minutes. Thereafter, 3 ml of a silicon alkoxide, here tetraethyl orthosilicate, was added, and reacted at room temperature for 24 hours. When the reaction was completed, ethanol was added, and the resulting mixture was then centrifuged to obtain a precipitate. The precipitate was re-dispersed and was washed by adding ethanol as described above.

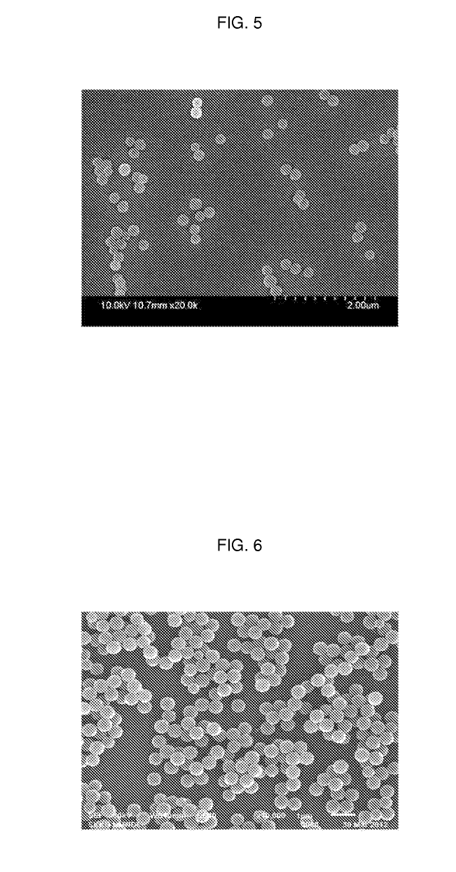

FIG. 5 is an enlarged image of the silica nanoparticles thus prepared, confirming the presence of the nanoparticles having a size distribution of approximately 200 to 220 nm.

442.8 ml of methanol, 142.7 ml of acetonitrile, 1.96 ml of distilled water, and 3.20 ml of dodecylamide were added at room temperature, and stirred for 10 minutes at 800 rpm. Then, 5.16 ml of titanium tetraisopropoxide was added, and the resulting mixture was reacted for 3 hour while stirring at 800 rpm. When the reaction was completed, ethanol was added, and the resulting mixture was then centrifuged to obtain a precipitate.

FIG. 6 is an enlarged image of the titania nanoparticles thus prepared, confirming the presence of the nanoparticles having a size distribution of approximately 550 to 600 nm.

In order to disperse the nanoparticles in a photocurable resin (for example, trimethylolpropane ethoxylate triacrylate), the nanoparticles dispersed in ethanol were mixed with the photocurable resin. A content of each of the nanoparticles was adjusted to 5% by weight (based on the total weight of the ethanol, photocurable resin, and nanoparticles), and the nanoparticles were mixed for 30 minutes using an ultrasonic cleaner so as to obtain a uniform solution. Thereafter, the uniform solution was dried at 50° C. for 3 hours in a rotary evaporator to remove ethanol.

Next, a photoinitiator, 2-hydroxy-2-methyl-1-phenyl-propan-1-one (Darocure 1173), was added at a content of approximately 5% by volume to the nanoparticle dispersion solution, based on the total volume of the nanoparticle dispersion solution, and the nanoparticle dispersion solution was then stirred for 5 minutes using an ultrasonic cleaner, thereby inducing uniform mixing of the photoinitiator.

Among the prepared dispersion solutions, the iron oxide/titania dispersion solution having high reflexibility was fed to one capillary tube, and the silica or titania dispersion solution was fed to the other capillary tube using two glass microdevices which were coupled to each other in a longitudinal direction. Droplets formed through the capillary tubes were cured by irradiation with UV rays to form fine particles having a double structure.

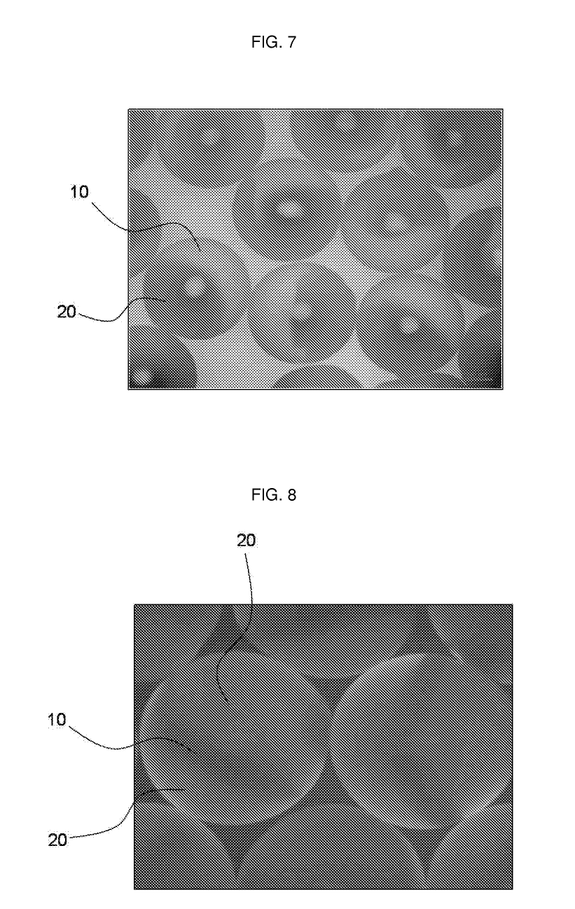

FIG. 7 is an enlarged image of the fine particles having a double structure, confirming the production of the fine particles, which include a reaction portion 10 containing the iron oxide/titania nanoparticles and a non-reaction portion 20 containing the silica or titania nanoparticles.

The iron oxide/titania dispersion solution having high reflexibility was fed to one capillary tube, and the silica or titania dispersion solution was fed to the other two capillary tubes using three glass microdevices which were coupled to each another in a longitudinal direction. Droplets formed through the capillary tubes were cured by irradiation with UV rays to form fine particles having a double structure.

FIG. 8 is an enlarged image of the fine particles having a triple structure, confirming the presence of the fine particles including one reaction portion 10 and two non-reaction portions 20.

The fine particles having a multiple structure manufactured in this procedure were mixed with polydimethylsiloxane (PDMS). The resulting mixture was kept at room temperature for approximately 15 minutes to remove bubbles formed during a mixing process, and then stored in a 70° C. oven for approximately 15 minutes to obtain a flexible and transparent polymer film.

In order to provide the fine particles having a multiple structure included in the polymer film with fluidity, the polymer film was input into a silicone oil for 3 hours. This results in the silicone oil being absorbed into the polymer film to form a space in which the fine particles having a double structure are able to flow.

Meanwhile, the fine particles having a multiple structure were dispersed in a solvent, other than the silicone oil, having a low dielectric constant. Then, the resulting dispersion solution was dropped in a rim of an ITO substrate having a barrier formed therein, and covered with an ITO substrate having no barrier formed therein to allow the fine particles to flow in the space formed in the polymer film.

The fine particles having a multiple structure may be rotated by applying the electric field or magnetic field to the polymer film prepared in this procedure. In this case, the light transmittance is controlled by rotation of the fine particles.

Using the fine particles having a multiple structure according to the present invention, the transmittance and durability of a smart window device for protecting infrared rays can be improved using the smart glass-related technology using dipole particles having a multiple structure. Further, manufacturing costs can be decreased and the technology can be more easily scaled up to ensure sufficient productivity.

Also, the prepared fine particles having a multiple structure can protect infrared rays based on the applied magnetic field, and the bistability can be realized to save energy required for driving. As a result, the prepared fine particles having a multiple structure can be applied to development of light protection technology and technology of suppressing an increase in internal temperature of a vehicle.

The present invention has been described in detail with reference to preferred embodiments thereof. However, it will be appreciated by those skilled in the art that changes may be made in these embodiments without departing from the principles of the invention, the scope of which is defined in the appended claims and equivalents thereof.

What is claimed is:

1. A fine particles having a multiple structure, comprising:
a reaction portion containing iron oxide nanoparticles, carbon black and/or carbon nanotubes; and
at least one non-reaction portion containing silica and/or titania nanoparticles.

2. The fine particles having a multiple structure of claim 1, wherein the reaction portion further comprises titania nanoparticles.

3. A polymer film for smart glass, comprising:
the fine particles having a multiple structure defined in claim 1; and
an elastomer.

4. The polymer film for smart glass of claim 3, wherein the elastomer is polydimethylsiloxane (PDMS).

5. A method of manufacturing a polymer film for smart glass, comprising:
a first operation of preparing nanoparticles;
a second operation of preparing a nanoparticle dispersion solution by dispersing the nanoparticles in a photocurable resin and adding a photoinitiator to the resulting dispersion solution;
a third operation of manufacturing fine particles having a multiple structure by inputting the nanoparticle dispersion solution into at least two glass microdevices coupled to each other in a longitudinal direction, and which are disposed in an outer tuber through which water and a surfactant flows, to form droplets and curing the nanoparticle dispersion solution; and
a fourth operation of manufacturing a polymer film by mixing the fine particles having a multiple structure with an elastomer.

6. The method of claim 5, further comprising:
a fifth operation of providing the fine particles having a multiple structure with fluidity by inputting the polymer film into a silicone oil.

7. The method of claim 5, wherein the nanoparticles include iron oxide and/or titania nanoparticles for forming a reaction portion; and
silica and/or titania nanoparticles for forming a non-reaction portion.

8. The method of claim 7, wherein the iron oxide nanoparticles are a reaction product between an iron oxide precursor and a solvent, the iron oxide precursor is iron(III) acetylacetonate, and the solvent is a mixture of octanol or 1,2-hexadecanediol and benzyl ether.

9. The method of claim 7, wherein the silica nanoparticles are a reaction product between a silica precursor, a solvent and a catalyst, the silica precursor is silicon alkoxide, the solvent is ethanol, and the catalyst is ammonium hydroxide.

10. The method of claim 7, wherein the titania nanoparticles are a reaction product between a titania precursor, a solvent and a catalyst, the titania precursor is titanium alkoxide, the solvent is a mixture of methanol or ethanol and acetonitrile, and the catalyst is a mixture of organoamine and water.

11. The method of claim 5, wherein the photocurable resin is trimethylolpropane ethoxylate triacrylate.

12. The method of claim 5, wherein the photoinitiator is 2-hydroxy-2-methyl-1-phenyl-propan-1-one.

13. The method of claim 5, wherein the second operation is performed by adding the photoinitiator at a content of about 0.1 to 5% by volume, based on a total volume of the nanoparticle dispersion solution.

14. The method of claim 5, wherein each of the glass microdevices is a glass capillary tube having a diameter of about 50 to 100 μm.

15. The method of claim 5, wherein the surfactant is sodium dodecyl sulfate (SDS) or a block terpolymer.

16. The method of claim 5, wherein the third operation is performed by curing the nanoparticle dispersion solution by irradiating the nanoparticle dispersion solution with ultraviolet rays having a wavelength of about 200 to 400 nm at a UV intensity of about 0.1 to 2.0 J/cm².

17. The method of claim 5, wherein the elastomer is PDMS.
